(19) United States
(12) Patent Application Publication
(10) Pub. No.: US 2007/0097952 A1
(43) Pub. Date: May 3, 2007

(54) Method and apparatus for dynamic optimization of connection establishment and message progress processing in a multifabric MPI implementation

(76) Inventors: Vladimir D. Truschin, Sarov (RU); Alexander V. Supalov, Erftstadt (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/261,998

(22) Filed: Oct. 27, 2005

(51) Int. Cl. H04L 12/28

(52) U.S. Cl. 370/351

(57) ABSTRACT

Connections are established and data passed over a plurality of heterogeneous communication fabrics by maintaining counts of expected connections and established connections over each fabric, and by attempting to establish a new connection only if a connection is expected, and attempting to exchange data over a fabric only if the number of established connections over the fabric is nonzero. Systems and other embodiments are also described and claimed.

### FIELD OF THE INVENTION

The invention relates to message passing infrastructure implementations. More specifically, the invention relates to techniques for improving the performance of Message Passing Interface (“MPI”) and similar message passing implementations in multifabric systems.

### BACKGROUND

Many computational problems can be subdivided into independent or loosely-dependent tasks, which can be distributed among a group of processors or systems and executed in parallel. This often permits the main problem to be solved faster than would be possible if all the tasks were performed by a single processor or system. Sometimes, the processing time can be reduced proportionally to the number of processors or systems working on the sub-tasks.

Cooperating processors and systems (“workers”) can be coordinated as necessary by transmitting messages between them. Messages can also be used to distribute work and to collect results. Some partitionings or decompositions of problems can place significant demands on a message passing infrastructure, either by sending and receiving a large number of messages, or by transferring large amounts of data within the messages.

Messages may be transferred from worker to worker over a number of different communication channels, or “fabrics.” For example, workers executing on the same physical machine may be able to communicate efficiently using shared memory. Workers on different machines may communicate through a high-speed network such as InfiniBand® (a registered trademark of the Infiniband Trade Association), Myrinet® (a registered trademark of Myricom, Inc. of Arcadia, Calif.), Scalable Coherent Interface (“SCI”), or QSNet by Quadrics, Ltd. of Bristol, United Kingdom. These networks may provide a native operational mode that exposes all of the features available from the fabric, as well as an emulation mode that permits the network to be used with legacy software. A commonly-provided emulation mode may be a Transmission Control Protocol/Internet Protocol (“TCP/IP”) mode, in which the high-speed network is largely indistinguishable from a traditional network such as Ethernet. Emulation modes may not be able to transmit data as quickly as a native mode.

To prevent the varying operational requirements of different communication fabrics from causing extra complexity in message-passing applications, a standard set of message passing functions may be defined, and “shim” libraries provided to perform the standard functions over each type of fabric. One standard library definition is the Message Passing Interface (“MPI”) from the members of the MPI Forum. An MPI (or similar) library may provide the standard functions over one or more fabrics. However, as the number of fabrics supported by a library increases, the message passing performance tends to decrease. Conversely, a library that supports only one or two fabrics may have better performance, but its applicability is limited. Techniques to improve the performance of a message passing infrastructure that supports many different communication fabrics may be of value in the field.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a flowchart of message channel establishment over a plurality of heterogeneous networks.

FIG. 2 is an expanded flowchart showing connection initialization.

FIG. 3 is a detailed flowchart of a portion of message channel establishment.

FIG. 4 shows a system that can implement an embodiment of the invention.

### DETAILED DESCRIPTION OF DRAWINGS

Embodiments of the invention can improve data throughput and message latency in a multi-fabric message-passing system by tracking the use of each fabric and avoiding operations on fabrics that are not expected to be active.

The examples discussed herein share certain non-critical features that are intended to simplify the explanations and avoid obscuring elements of the invention. These features include: worker processes are assumed to be identified by a unique, consecutive integer (which is called the process's rank). A cooperating process is assumed to establish a connection or message channel to every other worker over one of the available communication fabrics when the process starts. An out-of-band method to provide a certain amount of initialization data to a worker process may also be useful. Alternate methods of identifying worker processes may be used, and dynamic connection establishment and termination paradigms are also supported.

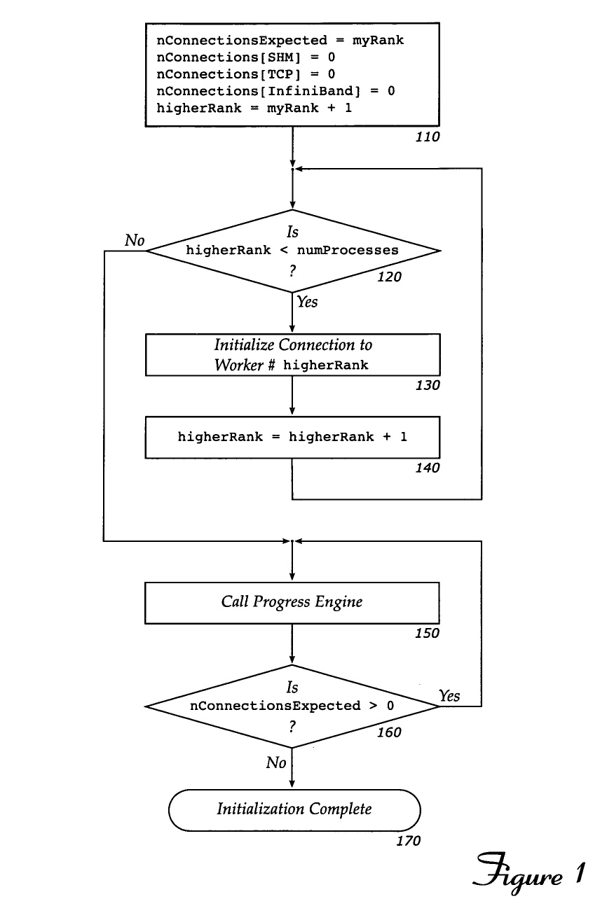

FIG. 1 is a flow chart of operations that might be performed to initialize a message passing infrastructure according to an embodiment of the invention. When a worker process starts, it initializes a number of variables that will be used later during initialization and operation (110). These variables include nConnectionsExpected, a count of connections expected to be established, and nConnections [fabric], counters of numbers of connections established over a particular fabric. nConnectionsExpected is initialized to the worker's own rank (myRank) to indicate that connections are expected from each lower-ranked process. Local iteration variable higherRank is used by the worker to connect to higher-ranked processes.

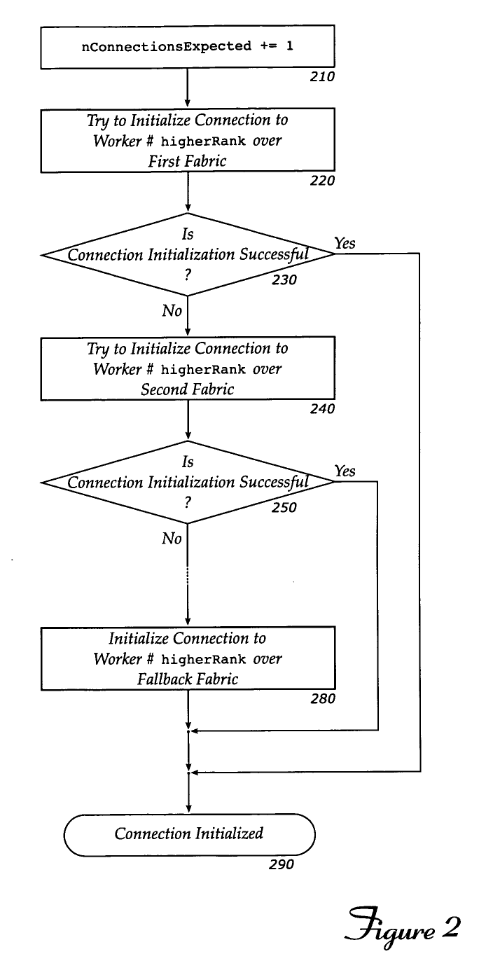

Next, the process loops to initialize an infrastructure for a connection to every worker of higher rank (120, 130, 140). If every worker follows this strategy, each worker will be able to establish a connection to every other worker. Initializing an infrastructure may entail opening a network socket, creating a shared memory segment, or configuring parameters of a high-speed communication fabric to support a connection. Details of this process are discussed with reference to FIG. 2.

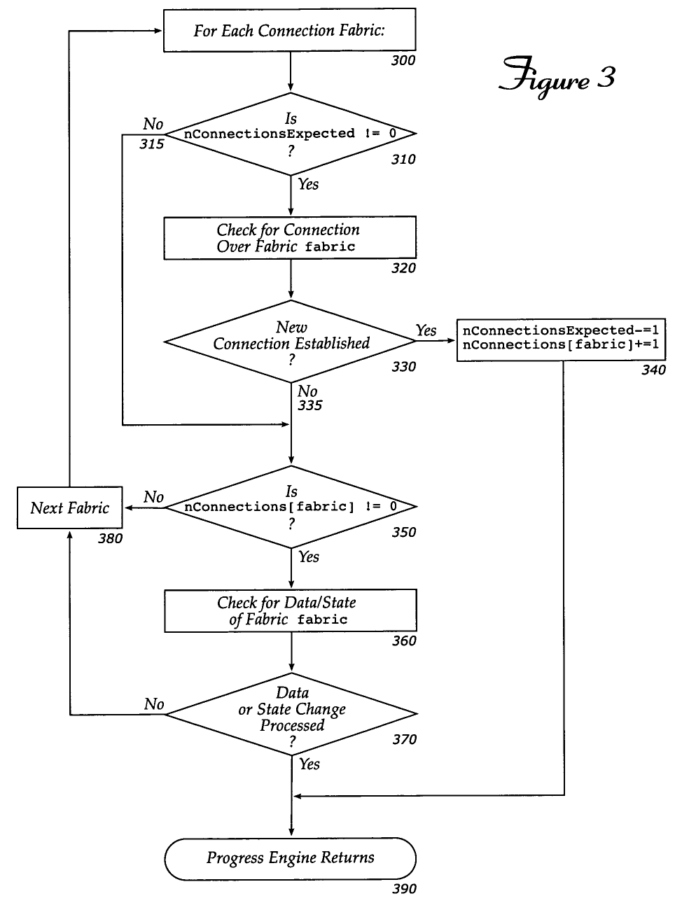

Once a connection has been initialized for each cooperating worker, the worker process enters a second loop to establish all the connections (150, 160). This second loop employs a subroutine known as a progress engine, which is described with reference to FIG. 3. The progress engine is called repeatedly, until all connections are established. After all the connections have been established, the message-passing infrastructure is initialized and workers can pass messages to coordinate their operations and perform their intended tasks.

FIG. 2 shows one way that a connection to a worker can be initialized. Initialized connections are not yet established, and no data can be passed over them. Initialization only lays the groundwork so that a data-passing connection may be established later. At 210, the number of connections expected is incremented to indicate that a connection to a higher-ranked worker is expected. Next, the process attempts to initialize a connection to worker number higherRank over a first communication fabric (220). If the initialization attempt is successful (230), the connection has been initialized (290). If unsuccessful, an attempt is made over a second fabric (240). If that attempt is successful (250), then the connection has been initialized (290). The connection initialization process continues, trying various available fabrics, and eventually (if all else fails), a connection over a fallback fabric is initialized (280).

The fabrics may be tried in a preferred order, for example, from fastest to slowest. Alteratively, information received through an out-of-band channel may guide the worker in choosing a fabric to initialize for a connection to another worker. For example, workers executing on the same machine may prefer to initialize and use a shared-memory channel, while workers on separate machines that each have InfiniBand® interfaces may prefer an InfiniBand® connection to another, slower fabric. A TCP/IP fabric may be used as a fallback, since it is commonly available on worker systems.

FIG. 3 shows the logical operation of the progress engine. In the embodiment described here, the progress engine is implemented as a subroutine that performs operations necessary to exchange messages with cooperating processes. At each invocation, the subroutine polls some or all of the communication fabrics in use to determine whether any of them has received new data or entered a new state requiring a response. In some embodiments, multiple progress engines may be provided (for example, one for each fabric); in other embodiments, the logic operations described may be performed by codes whose execution is interleaved with other operations in another manner.

Upon entry, the progress engine begins a loop over each of the communication fabrics it is to manage (300). If any connections are in progress (e.g. eat least one connection was initialized but has not been established, so a connection is expected) (310), then appropriate actions are taken to check for and process a connection over the current fabric (320). These actions may differ between fabrics, and might include calling a select( ) or poll( ) subroutine for a TCP/IP connection, or inspecting a shared memory location or interprocess communication object for shared memory. If a new connection is established (330), the counter of in-progress connections is decremented and a count of established connections over the particular fabric is incremented (340) and the progress engine returns (390).

If no connections are expected (315), or if no new connection was established over the current fabric (335), then the progress engine inspects an indicator such as a count of connections over the current fabric. If the indicator shows that connections have been established over the fabric (for example, if the count is non-zero (350)), appropriate actions are taken to check for received data or state changes on the fabric (360). These actions may differ between fabrics, and might include calling select( ) or poll( ), or read( ) or write( ) for a TCP/IP connection, or inspecting or changing a shared memory location or interprocess communication object for shared memory.

If any data is received or sent in response to a state change over the current fabric (370), the progress engine returns (390). Otherwise, the loop continues to manage the next communication fabric (380). Note that the loop divides the work of exchanging data between cooperating processes according to the communication fabric used to send or receive data. Even if two fabrics use identical semantics to establish connections and/or exchange data, so that their operations could theoretically be combined, an embodiment may nevertheless process the fabrics separately. An embodiment may terminate the progress engine after a single connection is serviced, or after servicing a single fabric (over which several connections might have been established).

In FIG. 3, the progress engine maintains (at 340) and examines (at 350) a count of connections established over each fabric (nconnections [fabric]) to decide whether to poll the fabric for data or state changes. However, alternate methods may be used instead to adjust the operation of the progress engine depending on whether activity on the fabric is expected. For example, an array of function pointers could indicate a servicing function for each different fabric. When a fabric had one or more connections established, its array entry would be updated to contain the address of a servicing function. If the fabric had no connections, the array entry would be empty. Then, the progress engine could call only the servicing functions listed in the array, skipping empty entries and thus fabrics with no connections established. In logical effect, a function pointer in the array serves as an indicator to permit the program to answer the question, “have any connections been established over this fabric?” and to service the fabric only if the answer is yes.

In some embodiments, the different communication fabrics may be sorted according to one or more characteristic properties and processed in the sorted order by the progress engine. Sorting may be done, for example, based on the fabrics' bandwidth, typical or measured latency, or round-trip transmission time.

Although the progress engine described with reference to FIG. 3 is discussed in the context of the message passing infrastructure initialization of FIG. 1, the engine can also be used during normal worker operations (e.g. after initialization is complete) to perform ordinary data and message exchange. By calling the progress engine periodically (at fixed or variable intervals) a worker can ensure that it receives messages it needs to perform its work, and that it delivers information to its peers to permit them to proceed. The logic embodied in the progress engine may be subdivided into smaller units and the operations performed separately or in different order to achieve architectural goals of the program designer. The individual-fabric servicing functions mentioned above are one example of subdividing the progress engine logic into smaller units.

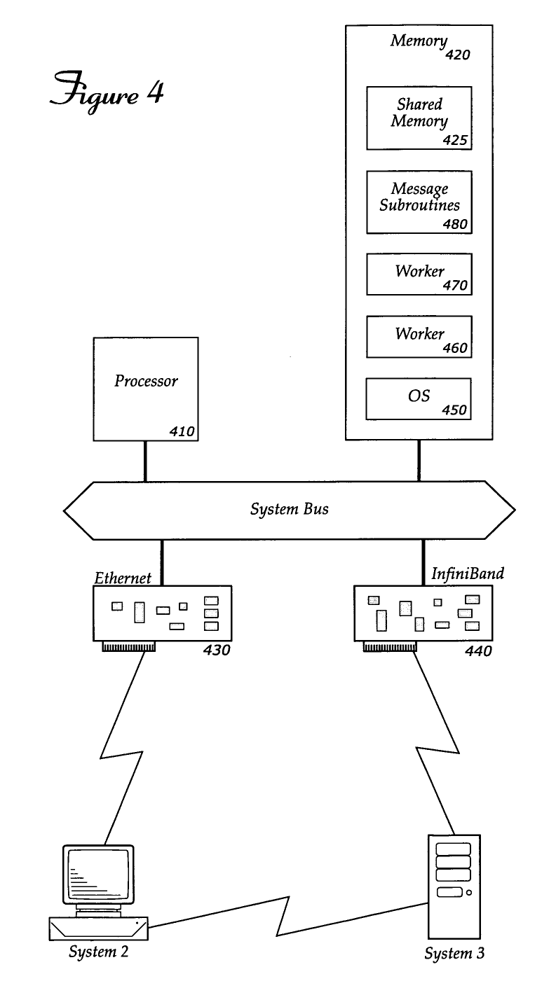

Embodiments of the invention can be used with one or more systems similar to that shown in FIG. 4. The system contains a processor 410 such as a microprocessor or central processing unit (“CPU”); a memory 420; and one or more communication interfaces. The system shown in this figure has an Ethernet interface 430 and an InfiniBand® interface 440. Also, the system employs a multitasking operating system (“OS”) 450, so it can execute two worker processes 460, 470 in a time-sliced fashion. Processes 460 and 470 both have access to memory 420, so a portion 425 of that memory can be shared between the processes and used as a shared-memory communication fabric. Other systems that can implement an embodiment of the invention may have multiple processors, different operating systems, and different numbers or types of communication interfaces.

Any of these systems can be provided with a subroutine 480 or other executable instruction sequence to perform the methods described above with reference to FIGS. 1, 2 and 3. Message passing can occur between two or more worker processes, whether those processes are located on the same machine or different machines. The subroutine or other instruction sequence can provide a unified view of the underlying heterogeneous communication interfaces, so that the worker processes need not directly manage each different type of interface. The subroutine, operating according to the methods discussed, will service an interface only if connections have been established over the interface. Furthermore, in some embodiments, the subroutine will complete no more than one operation (either connection establishment or data exchange) over one fabric during a single invocation. The subroutine may even limit its operation to exchanging data over a single connection between two cooperating workers, instead of servicing all connections that are established over the one fabric.

An embodiment of the invention may be a machine-readable medium having stored thereon instructions which cause a processor to perform operations as described above. In other embodiments, the operations might be performed by specific hardware components that contain hardwired logic. Those operations might alternatively be performed by any combination of programmed computer components and custom hardware components.

In one embodiment, instructions to direct a processor may be stored on a machine-readable medium in a human-readable form known as source code. This is a preferred form for reading and modifying the instructions, and is often accompanied by scripts or instructions that can be used to direct a compilation process, by which the source code can be placed in a form that may be executed by a processor in a system. Source code distributions may be particularly useful when the type of processor or operating system under which the embodiment of the invention will be used is not known beforehand.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), Erasable Programmable Read-Only Memory (EPROM), and a transmission over the Internet.

The applications of the present invention have been described largely by reference to specific examples and in terms of particular allocations of functionality to certain hardware and/or software components. However, those of skill in the art will recognize that a multi-fabric, message passing infrastructure can also be implemented by software and hardware that distribute the functions of embodiments of this invention differently than herein described. Such variations and implementations are understood to be apprehended according to the following claims.

We claim:

1. A method comprising:
maintaining a first count of a number of connections expected to be established over a plurality of heterogeneous communication fabrics;
maintaining an indicator of connections established over a one of the plurality of fabrics;
attempting to establish a new connection only if the first count is non-zero; and
attempting to exchange data over the fabric only if the indicator shows that a connection was established.

2. The method of claim 1, further comprising:
decrementing the first count if an attempt to establish a new connection is successful.

3. The method of claim 2 wherein the indicator is a second count of connections established over a one of the plurality of fabrics, the method further comprising:
incrementing the second count if the new connection is established over the fabric.

4. The method of claim 1, further comprising:
sorting the plurality of communication fabrics according to a characteristic property; and
attempting to establish a new connection over the plurality of fabrics in an order determined by the sorting.

5. The method of claim 1, further comprising:
sorting the plurality of communication fabrics according to a characteristic property;
iterating over the sorted plurality of fabrics; and
attempting to exchange data over a fabric only if an indicator shows that a connection was established over the fabric.

6. The method of claim 5, further comprising:
terminating the iteration if data is successfully exchanged over a fabric.

7. The method of claim 5 wherein the characteristic property is one of a bandwidth, a typical latency, and a round-trip time.

8. The method of claim 1 wherein the plurality of heterogeneous communication fabrics comprises at least three of shared memory, InfiniBand®, Myrinet®, Scalable Coherent Interface, QSNet and Ethernet.

9. A computer-readable medium containing instructions that, when executed by a processor, cause the processor to perform operations comprising:
attempting to establish a connection over a communication fabric if a number of expected connections is greater than zero;
if no connection is established, then iterating over a plurality of different communication fabrics and, for each fabric,
polling for data to exchange if a connection has been established over the fabric; and
terminating the iteration if data are successfully exchanged.

10. The computer-readable medium of claim 9, containing additional instructions to cause the processor to perform operations comprising:
sorting the plurality of different communication fabrics according to a property of the fabric; and
iterating over the plurality of different fabrics in an order established by the sorting.

11. The computer-readable medium of claim 9, containing additional instructions to cause the processor to perform operations comprising:
decrementing the number of expected connections if the attempt to establish a connection is successful.

12. The computer-readable medium of claim 9, containing additional instructions to cause the processor to perform operations comprising:
receiving data from a communication peer over a shared-memory channel.

13. The computer-readable medium of claim 9 wherein the instructions comprise a library to implement a message passing interface (“MPI”).

14. The computer-readable medium of claim 9 wherein the instructions comprise a script to direct a compilation process.

15. A system comprising:
a processor;
a memory;
a plurality of different communication interfaces; and
a subroutine to exchange data over at least one of the plurality of interfaces; wherein
the system is to communicate with a first peer over a first communication interface and with a second peer over a second communication interface; and
the subroutine services an interface only if a connection has been established over the interface.

16. The system of claim 15 wherein the subroutine accepts data over no more than one connection during an invocation of the subroutine.

17. The system of claim 15 wherein the subroutine accepts data over no more than one interface during an invocation of the subroutine.

18. The system of claim 15 wherein the plurality of different communication interfaces comprises at least two of shared memory, InfiniBand®, Myrinet®, Scalable Coherent Interface, QSNet and Ethernet.
